(19) United States
(12) Patent Application Publication
(10) Pub. No.: US 2005/0255379 A1
(43) Pub. Date: Nov. 17, 2005

(54) Battery assembly with heat sink

(76) Inventors: Michael Marchio, Clarkston, MI (US); Richard Bendert, Rochester Hills, MI (US)

Correspondence Address: ENERGY CONVERSION DEVICES, INC., 2956 WATERVIEW DRIVE, ROCHESTER HILLS, MI, 48309, US

(21) Appl. No.: 10/844,215

(22) Filed: May 12, 2004

(51) Int. Cl. H01M 2/02

(52) U.S. Cl. 429/153; 429/176

(57) ABSTRACT

A multi-cell battery comprising a housing having one or more partitions dividing the housing into a plurality of regions. A dielectric material lines the surfaces of the housing within each of the regions and an electrochemical cell is disposed within each of the regions. The housing is used as a heat sink to draw heat away from the individual electrochemical cells during operation.

### FIELD OF THE INVENTION

The instant invention relates generally to improvements in rechargeable electrochemical cells and batteries. Specifically, the invention relates to multi-cell batteries and thermal management issues pertaining to multi-cell batteries.

### BACKGROUND OF THE INVENTION

Rechargeable nickel-metal hydride (Ni-MH) batteries are used in a variety of industrial and commercial applications such as fork lifts, golf carts, uninterruptable power supplies, pure electric vehicles and hybrid electric vehicles. Vehicular applications include applications related to propulsion as well as applications related to starting, lighting and ignition (“SLI”). The Ovonic Battery Company (“OBC”) has developed high energy and high power nickel-metal hydride batteries for many different applications. Extensive research has been conducted by OBC scientists and engineers in improving all aspects of battery operation.

One aspect of battery operation that is particularly important for electric vehicle and hybrid vehicle applications is that of thermal management. In both electric and hybrid vehicle applications individual electrochemical cells are bundled together in close proximity. Many cells are both electrically and thermally coupled together. Therefore, the nickel-metal hydride batteries used in these applications may generate significant heat during operation. Sources of heat are primarily threefold. First, ambient heat due to the operation of the vehicle in hot climates. Second, resistive or I²R heating on charge and discharge, where I represents the current flowing into or out of the battery and R is the resistance of the battery. Third, a tremendous amount of heat is generated during overcharge due to gas recombination.

While issues regarding heat dissipation are generally common to all electrical battery systems, they are particularly important to nickel-metal hydride battery systems. This is because Ni-MH has a high specific energy and the charge and discharge currents are also high. Second, because Ni-MH has an exceptional energy density (i.e. the energy is stored very compactly) heat dissipation is more difficult than, for example, lead-acid batteries. This is because the surface-area to volume ratio is much smaller than lead-acid, which means that while the heat being generated is much greater for Ni-MH batteries than for lead acid, the heat dissipation surface is reduced.

In addition, while the heat generated during charging and discharging Ni-MH batteries is normally not a problem in small consumer batteries however, larger batteries (particularly when more than one is used in series or in parallel) generate sufficient heat on charging and discharging to affect the ultimate performance of the battery.

Thermal management issues for nickel-metal hydride batteries are addressed in U.S. Pat. No. 6,255,015, in U.S. patent application Ser. No. 09/861,914 and in U.S. patent application Ser. No. 10/391,886. U.S. Pat. No. 6,255,015, U.S. patent application Ser. No. 09/861,914 and U.S. patent application Ser. No. 10/391,886 are all incorporated by reference herein.

There exists a need in the art for additional battery designs which incorporate the necessary thermal management needed for successful operation of the battery without reducing its energy storage capacity or power output.

### SUMMARY OF THE INVENTION

Disclosed herein is a multi-cell battery, comprising: a housing having one or more partitions dividing the housing into a plurality of regions; a dielectric material lining the surfaces of the housing within each of the regions; and a plurality of electrochemical cells disposed within the regions, wherein the thermal conductivity of the housing is greater than the thermal conductivity of the dielectric material. Preferably, the multi-cell battery forms a single pressure vessel for each of the electrochemical cells included within the battery.

Also disclosed herein is a multi-cell battery case, comprising: a housing having one or more partitions dividing the housing into a plurality of regions; and a dielectric material lining the surfaces of the housing within each of the regions, the thermal conductivity of the housing being greater than the thermal conductivity of the dielectric material.

Also disclosed herein is a multi-cell battery, comprising: a housing having one or more partitions dividing the housing into a plurality of regions; a plurality of electrochemical cells disposed within the regions; and a dielectric material between the housing and the electrochemical cells, the thermal conductivity of the housing being greater than the thermal conductivity of the dielectric material.

### BRIEF DESCRIPTION OF THE DRAWINGS

FIG. 1 is a three-dimensional view of an embodiment of a battery assembly of the present invention;

FIG. 2 is an exploded view of the battery assembly of FIG. 1;

FIG. 3 is a three-dimensional view of an embodiment of the battery housing of the present invention that serves as a heat sink for the electrochemical cells included within the battery;

FIG. 4 is a cross-sectional view of an embodiment of a battery container of the present invention showing how the battery housing, inserts and manifold are assembled;

FIG. 5 is a cross-sectional view of an embodiment of a battery of the present invention showing the electrical connections of the electrochemical cells; and

FIG. 6 is a cross-sectional view of an embodiment of a battery container of the present invention showing that a dielectric material may be molded about the surfaces of the battery housing.

### DETAILED DESCRIPTION OF THE INVENTION

Disclosed herein is a multi-cell battery that comprises a plurality of electrochemical cells. The multi-cell battery of the present invention preferably serves as a single pressure vessel for each of the electrochemical cells included within the battery.

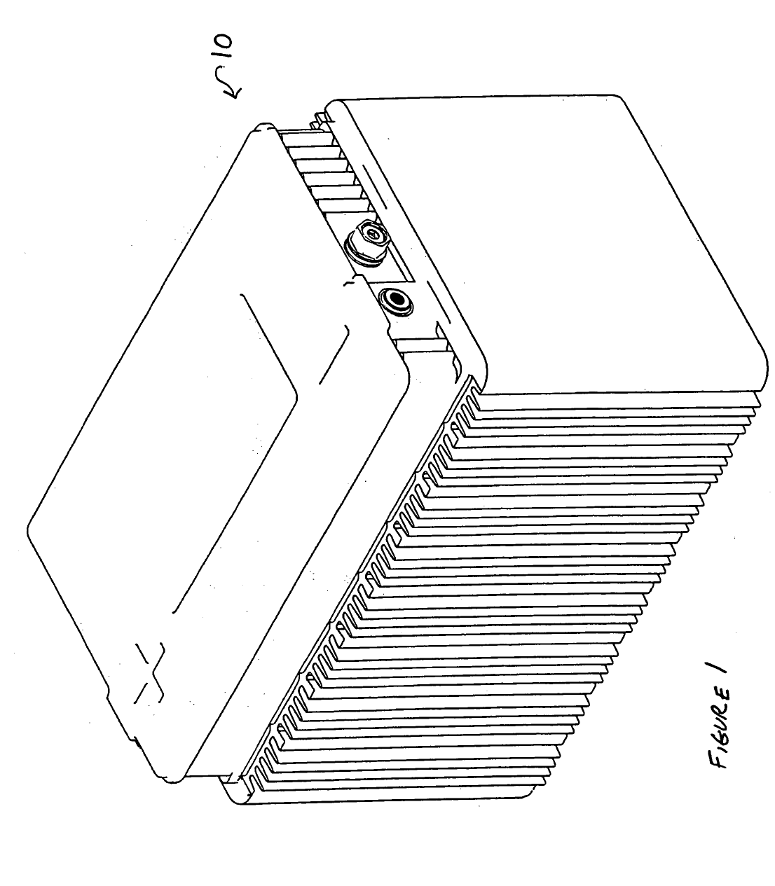

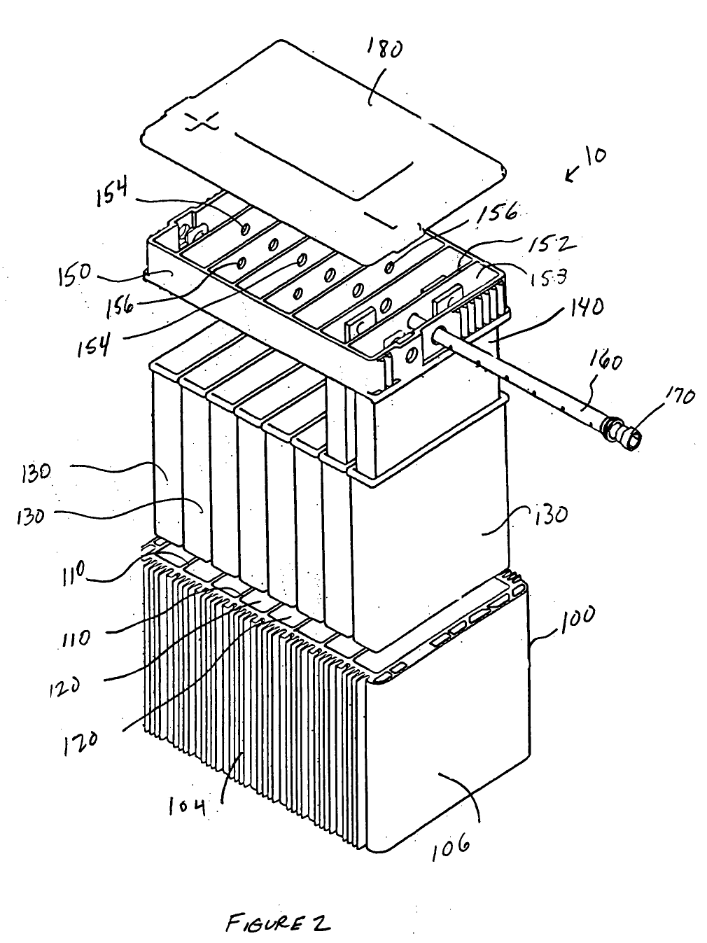

FIG. 1 shows a three-dimensional view of the multi-cell battery 10 of the present invention. FIG. 2 shows an exploded view of the multi-cell battery from FIG. 1. Referring to FIG. 2, the battery 10 includes a housing 100. The housing 100 includes one or more partitions 110 that divide the interior of the housing into a plurality of regions 120. The battery 10 further includes a plurality of inserts 130. Each of the inserts 130 is disposed into a corresponding region 120. The battery further includes a plurality of electrochemical cells 140. Each of the electrochemical cells 140 is disposed into the interior of a corresponding insert 130 within a region 120. Each of the electrochemical cells preferably include one or more positive electrodes, one or more negative electrodes, separators and electrolyte.

The battery 10 further comprises a manifold 150 that is disposed so that it fits on top of the inserts 130. The manifold 150 is preferably vibration welded to the inserts 130. The manifold itself may include one or more partitions 152 that divide the manifold into regions 153. When the manifold is placed on top of the inserts, each of the regions 153 of the manifold is aligned with a corresponding top opening of an insert. Hence, the gases from the electrochemical cell that is disposed within a corresponding insert 130 enters the corresponding region of the manifold.

A vent tube 160 is disposed through openings 154 that are within the partitions 152 of the manifold 150. The vent tube 160 includes holes 162 that serve to collect the gases produced by the electrochemical cells. In the particular embodiment shown, the holes 162 are arranged so that a hole is positioned above a corresponding electrochemical cell. The gases from each of the electrochemical cells thus enters the vent tube 160 through the holes 162. All of the gases from the electrochemical cells are collected into the vent tube 160 and intermix within the vent tube 160. Attached to the vent tube is a vent 170. When the pressure from the collected gases gets sufficiently high, the vent 170 opens to allow the gases to escape from the vent tube 160. The vent tube 160 is preferably formed of a dielectric material such as a plastic material.

A cover 180 is placed over the cell manifold 150. Preferably, the cover 180 is sealed tightly over the top of the manifold so one that electrolyte from one of the electrochemical cells cannot enter any of the other electrochemical cells. As noted, in the embodiment of the invention shown in FIG. 2, the gases from each of the electrochemical cells are permitted to intermix within the vent tube 160 so that each of the electrochemical cells is in gaseous communication with the other electrochemical cells. In this embodiment, the battery acts as a single pressure vessel for each of the individual electrochemical cells. Additionally, in this embodiment, the battery would be considered to be of a monoblock design. It is noted that in FIG. 2, the “battery case” is the battery 10 minus the electrochemical cells 140.

In another embodiment of the invention, it is possible that the battery be designed so that each of the electrochemical cells is gaseously isolated from the other electrochemical cells. In this case, the gases from one cell do not intermix with the gases from any of the other cells. Implementation of a design of this nature may require separate gas vents for each of the electrochemical cells.

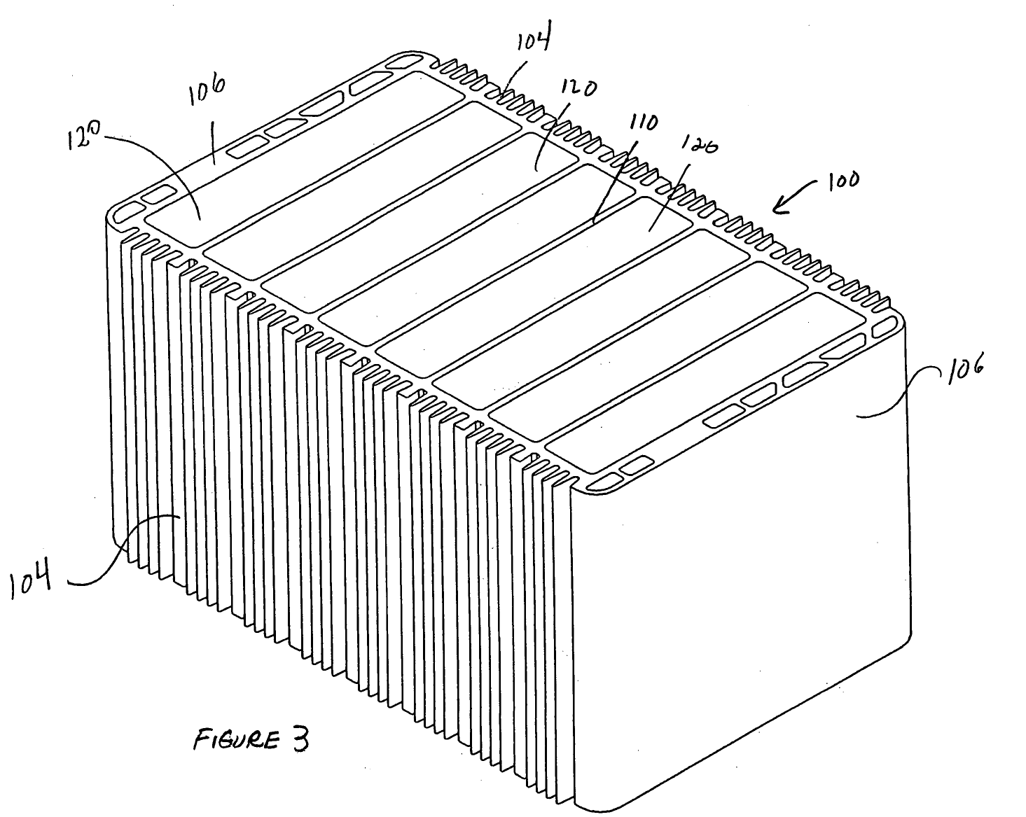

A more detailed view of the battery housing 100 is shown in FIG. 3. The battery housing serves as a heat sink for the heat generated by each of the electrochemical cells. That is, the battery housing draws heat away from each of the electrochemical cells. For this purpose, the battery housing is preferably made from a material that has a good thermal conductivity. Preferably, the material of the battery housing is chosen so that its thermal conductivity is greater than the thermal conductivity of the dielectric material of the inserts. The battery housing may be made from any material having the appropriate thermal conductivity. The battery housing may be made from a metallic material such as a pure metal or a metal alloy. For example, the battery housing may be made from aluminum. Alternately, it is also possible that the battery housing be made of a polymeric material such as a plastic or a rubber.

FIGS. 2 and 3 show the partitions 110 and the regions 120 of the housing. The housing 100 includes walls 104 and 106. The walls 104 may also be referred to as the side walls of the housing 100 since they are preferably positioned to be parallel with the thin sides of the electrodes that are placed within the regions. The walls 106 may also be referred to as the end walls of the housing since they are preferably positioned to be parallel to the wide sides of the electrodes placed within the regions. To help prevent the end walls of the battery housing from bulging out, the end walls 106 may be designed to include a truss-like system as shown in FIG. 3. To increase the heat sinking capabilities of the battery housing 100, the battery housing may be designed so that one or more of the walls has a corrugated “fin-like” design to increase the surface area of the walls and thereby improve the heat dissipation capabilities. In the embodiment shown in FIG. 3, these fins are formed into the side walls 104 of the housing.

The battery housing 100 may be made using an extrusion process. The embodiment of the battery housing 100 shown in FIG. 3 is made using an extrusion process. In this case, the battery housing is opened on both its top and its bottom. However, the battery housing may be made so that it has an open end on top and a closed end on the bottom.

In addition, in the embodiment shown in FIG. 3, the battery housing 100 is made so that the end walls, side walls and partitions are integrally formed as a one-piece construction. However, it is also possible that separate pieces be made which are then integrally attached together (by, for example, welding, brazing, soldering or gluing).

Referring again to FIG. 2, each of the inserts 130 is preferably made from a dielectric material. The dielectric material used may be any dielectric known in the art. Preferably, the dielectric material is a plastic. Other materials such a rubber, glass or ceramic materials are also possible. Other non-conductive polymers may also be used. When the inserts are disposed within the regions 120 of the battery container 100, the dielectric material of the inserts lines the surfaces of the housing 100 within each of the regions 120 (in the embodiment shown in FIG. 2, this corresponds to surfaces of the partitions 110 as well as to the interior surfaces of the side walls 104 and the end walls 106). Hence, the dielectric material of the inserts serves to electrically insulate the electrochemical cells 140 from the surfaces of the battery housing 100. It is noted that the dielectric material of the inserts 130 may or may not be in intimate contact with the surfaces of the battery housing 100.

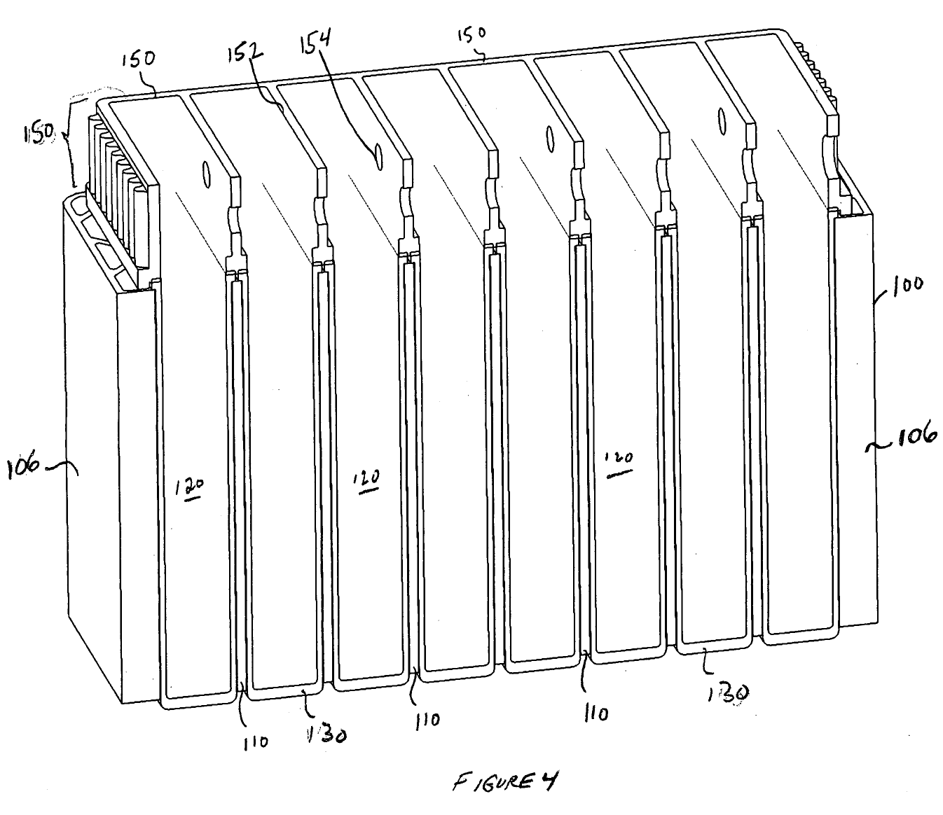

A cross-sectional view of an embodiment of a battery container of the present invention that includes the battery housing 100, inserts 130 and manifold 150 is shown in FIG. 4. FIG. 4 shows the end walls 106 and partitions 110 of the battery housing 100. Also, shown are the partitions 152 and the openings 154 of the manifold 150. In the embodiment shown in FIG. 4, each of the inserts 130 is in the form of a cup-like container that includes sides as well as a bottom surface (so that there is an open end on top and a closed end on the bottom). However, it is possible that the inserts 130 be made without a bottom surface so that they are each open at the top as well as at the bottom. An additional dielectric bottom surface may be attached to the bottom of the battery housing to cover the bottom openings of the inserts. FIG. 4 shows how the material of the inserts 130 lines the surfaces of the housing 100 within each of the regions 120. The manifold 150 may be vibration welded to the tops of each of the inserts 130.

In the embodiment shown in FIG. 2, an individual electrochemical cell is disposed within a corresponding insert. Each of the electrochemical cells are then connected together is electrical series. The individual electrochemical cells may be coupled together in electrical series in many different ways.

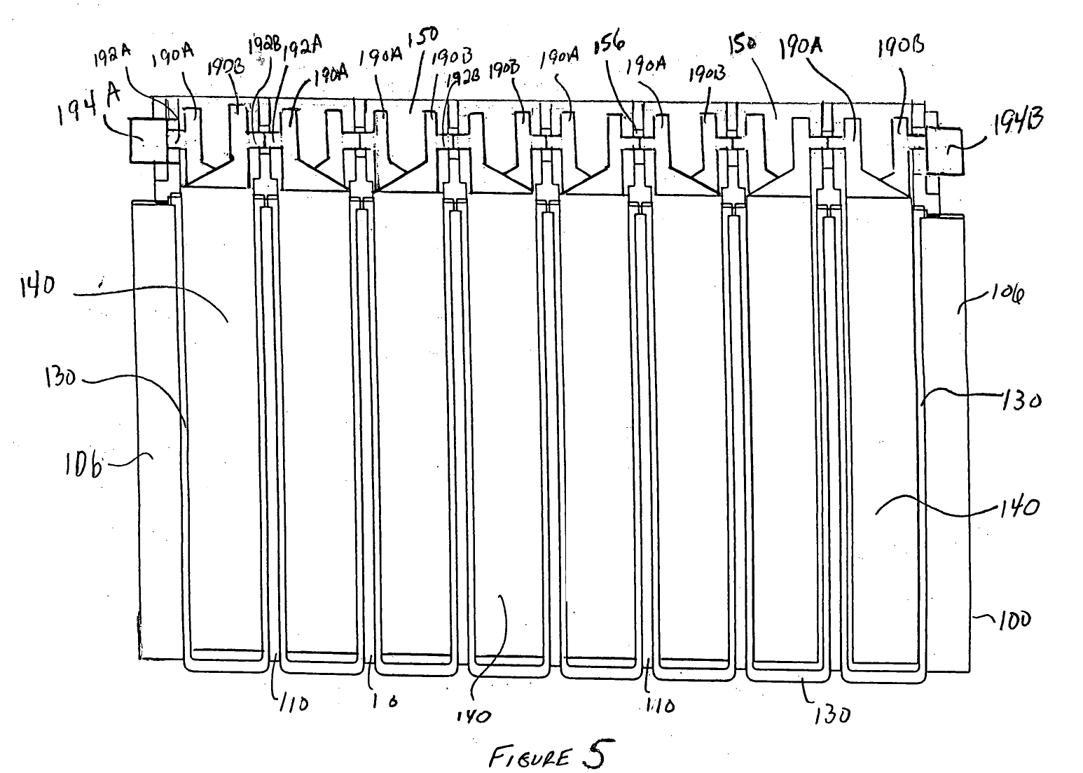

FIG. 5 shows a cross-sectional view of the battery container from FIG. 4 that also includes electrochemical cells disposed within the inserts 130. FIG. 5 shows the end walls 106 and partitions 110 of the battery housing 100. Also shown is the manifold 150 as well as the partitions 152 of the manifold 150. Inserts 130 are disposed within the regions defined by the partitions 110 and walls of the battery housing. An individual electrochemical cell 140 is disposed within each of the inserts 130. FIG. 5 shows how the material of the inserts 130 insulates the electrochemical cells from the partitions 110, end walls 106 and side walls of the battery housing. FIG. 5 also shows how each partition 110 of the housing is disposed between and is in close proximity with two of the electrochemical cells of the battery so as to be in position to draw heat from these cells.

In the embodiment shown in FIG. 5, the plurality of electrochemical cells are electrically coupled in series. The electrical coupling between adjacent cells may be accomplished in different ways. In the embodiment shown, the positive and negative electrodes include current collection tabs attached to the electrodes for transporting electrical energy into and out of the electrodes. The current collection tabs of the positive electrodes are all welded together into a positive interconnect 190A. Likewise, the current collection tabs of the negative electrodes are all welded together into a negative interconnect 190B. To connect the electrochemical cells in series, the positive interconnect of one electrochemical cell is electrical coupled to the negative interconnect of an adjacent electrochemical cell that is on the opposite side of the partition.

The positive interconnect 190A and the negative interconnect 190B are each formed to have protrusions 192A and 192B that extend through the openings 156 in the walls of the manifold. The positive interconnect protrusion 192A makes physical and electrical contact with the negative interconnect protrusion 192B. Hence, the corresponding positive and negative electrodes are electrically coupled. Preferably, the positive interconnect protrusion 192A is welded to the negative interconnect protrusion 192B. It is noted that the battery includes the positive battery terminal 194A and a negative battery terminal 194B.

In an alternate embodiment of the invention, the positive electrodes of one electrochemical cell may be coupled to the negative electrodes of the next electrochemical cell by placing a connection spacer through an opening in the cell manifold and welding the ends of the connection spacer to the positive interconnect and the negative interconnect that are on the opposite sides of the partition. Connection spacers may also placed through openings in the end walls to electrically connect a positive interconnect to the positive battery terminal and a negative interconnect to the negative battery terminal. The connection spacer may comprise nickel, copper, a nickel alloy, a copper alloy, a nickel-copper alloy, a copper-nickel alloy. Further the connection spacer may comprise both copper and nickel. For example, the connection spacer may comprise nickel-plated copper, or the connection spacer may comprise a copper control portion surrounded by nickel. Alternatively, the connector may comprise a copper cylinder and a nickel wire which is spirally wrapped along the length of the copper cylinder.

Referring again to FIG. 2, the openings 154 and 156 in the cell partitions may be sealed to prevent electrolyte communication from one of the cell compartments to the adjacent cell compartment on the other side of the cell partition. The sealing may be accomplished by using a polymer gasket such as a rubber or a plastic gasket. Sealing may also be accomplished by a hot melt adhesive or an epoxy adhesive. Sealing may also be accomplished by melting the plastic material of the partition around the gas tube, connection protrusion and/or connection spacer.

In yet another embodiment of the invention, the positive and negative electrodes may be interconnected over the cell partitions rather than through the cell partitions. This may be done in different ways, such as by extending the positive interconnects and/or the negative interconnects over the cell partitions. It may also be done by positioning an interconnect spacer over the cell partitions. The electrolyte of each cell is isolated from the remaining cells and the single battery serves as an enclosure for all of the cells and as a single pressure/gas container.

In the embodiment shown in FIG. 5, all of the electrochemical cells are coupled in series. However, it is also possible that the cells be coupled in parallel. In addition, some of the cells may be coupled in series while others are connected in parallel. Some or all of the electrochemical cells may be electrically coupled together in a serial electrical connection and/or a parallel electrical connection. It is also possible that one or more of the cells are not electrically connected to any of the other cells. In one embodiment, all of the electrochemical cells are electrically coupled in series. In another embodiment, all of the electrochemical cells are electrically coupled in parallel. In yet another embodiment, a portion of the electrochemical cells are electrically coupled in series while a portion are electrically coupled in parallel.

In the embodiment of the invention shown in FIG. 2, a single electrochemical cell is disposed into an insert 130. However, it is also conceivable that the insert itself include partitions that would divide the insert into a plurality of regions. Each of the regions within an insert could house a single electrochemical cell so that the insert itself could house a plurality of electrically coupled electrochemical cells.

It is further noted that in the embodiment shown in FIG. 2, each of the inserts 130 as well as the manifold 150 is formed as a separated piece. It is also possible that all or some of the individual inserts 130 be attached together. It is also possible that all of the inserts 130 be formed as a single-piece construction. In addition, it is also possible that all of the inserts 130 as well as the manifold 150 be formed as a single-piece construction.

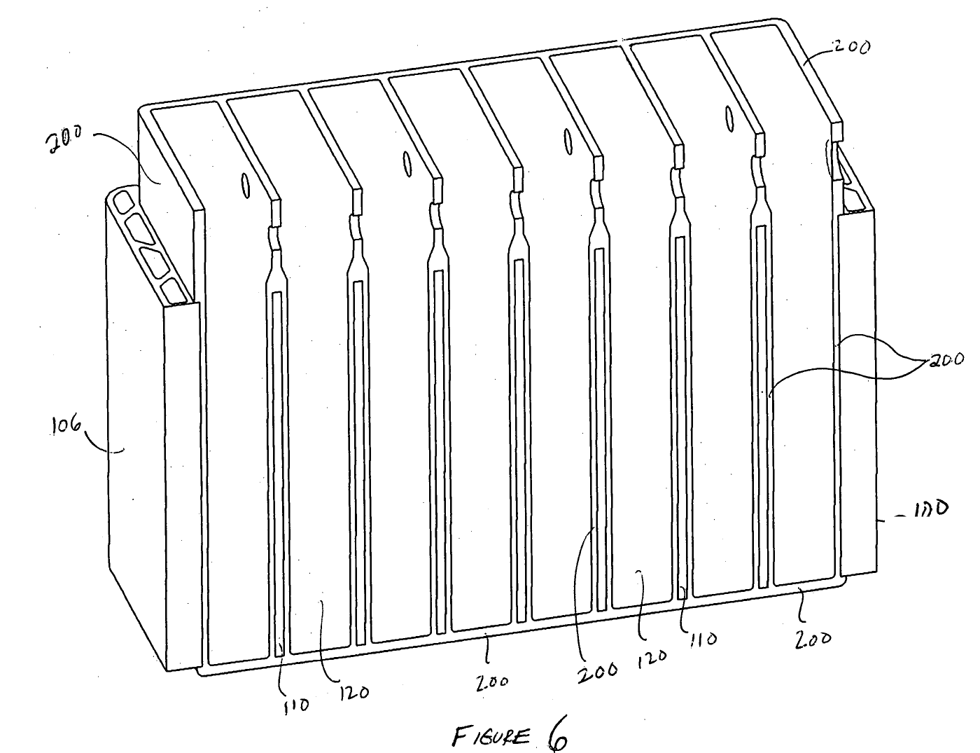

Referring again to FIG. 2, as noted above, when the inserts 130 are disposed within the regions 120 of the battery housing 100, the dielectric material of the inserts lines the surfaces of the housings within each of the regions 120 so that the electrochemical cells are electrically isolated from the surfaces of the battery housing 100. In another embodiment of the present invention, it is possible to cover the surfaces of the battery housing within each of each of the regions 120 with a dielectric material. The dielectric material may be applied in any manner. For example, the dielectric material may be applied by a spray process, a dipping process or by a molding process. In particular, the dielectric material may be applied to the surfaces of the battery housing by using a molding process wherein the battery housing is placed in a mold and a dielectric material is molded about the surfaces. A cross-sectional view of a battery container of the present invention that is formed using a molding process is shown in FIG. 6. Referring to FIG. 6, it is seen that a dielectric material 200 is molded about surfaces of the partitions 110, end walls 106 and side walls (not seen) that define the regions 120. By using a molding process, all of the inserts as well as the manifold of battery are formed as a single piece of dielectric material.

Regardless of how the dielectric material is applied, the dielectric material 200 still lines the surfaces of each of the regions 120 and serves to electrically insulate the electrochemical cells placed within the regions 120 from the surfaces of the battery housing.

The electrochemical cells are preferably nickel-metal hydride cells. In this case the negative electrodes of each cells are formed of hydrogen storage alloy active materials and the positive electrodes of each cell are formed of nickel hydroxide active materials. As well, the electrolyte is preferably an alkaline electrolyte. The alkaline electrolyte is preferably an aqueous solution of an alkali metal hydroxide. The alkali metal hydroxide may be chosen from the group consisting of sodium hydroxide, lithium hydroxide and potassium hydroxide.

The battery design may be used for all battery chemistries and all electrode materials. The electrode materials may be divided into positive electrode materials and negative electrode materials. Examples of positive electrode materials are powders of lead oxide, lithium cobalt dioxide, lithium nickel dioxide, lithium nickel dioxide, lithium manganese oxide compounds, lithium vanadium oxide compounds, lithium iron oxide, lithium compounds, i.e., complex oxides of these compounds and transition metal oxides, manganese dioxide, zinc oxide, nickel oxide, nickel hydroxide, manganese hydroxide, copper oxide, molybdenum oxide, carbon fluoride, etc. Examples of negative electrode materials include metallic lithium and like alkali metals, alloys thereof, alkali metal absorbing carbon materials, zinc, cadmium hydroxide, hydrogen storage alloys, etc.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A multi-cell battery, comprising:
a housing having one or more partitions dividing said housing into a plurality of regions;
a dielectric material lining the surfaces of said housing within said regions, the thermal conductivity of said housing being greater than the thermal conductivity of said dielectric material; and
a plurality of electrochemical cells disposed within said regions.

2. The battery of claim 1, wherein said housing consists essentially of a metallic material.

3. The battery of claim 1, wherein said housing consists essentially of aluminum.

4. The battery of claim 1, wherein said dielectric material is a plastic.

5. The battery of claim 1, wherein said battery forms a single pressure vessel for each of the electrochemical cells.

6. The battery of claim 1, wherein said dielectric material comprises a plurality of dielectric inserts, each of said inserts disposed within a corresponding region of said housing.

7. The battery of claim 6, wherein one of said electrochemical cells is disposed in a corresponding region.

8. The battery of claim 1, wherein said dielectric material is molded about the surfaces of said housing within said regions.

9. The battery of claim 1, wherein said housing is formed as a one-piece construction.

10. The battery of claim 1, wherein said housing is formed by extrusion.

11. The battery of claim 1, wherein said dielectric material is in intimate contact with the surfaces of said housing within said regions.

12. The battery of claim 1, wherein said electrochemical cells are nickel-metal hydride electrochemical cells.

13. The battery of claim 1, wherein said electrochemical cells are coupled in series.

14. A multi-cell battery case, comprising:
a housing having one or more partitions dividing said housing into a plurality of regions; and
a dielectric material lining the surfaces of said housing within said regions, the thermal conductivity of said housing being greater than the thermal conductivity of said dielectric material.

15. The battery of claim 14, wherein said housing consists essentially of a metallic material.

16. The battery of claim 14, wherein said battery case is a single pressure vessel.

17. The battery of claim 14, wherein said dielectric material comprises a plurality of dielectric inserts, each of said inserts disposed within a corresponding region of the housing.

18. The battery of claim 14, wherein said dielectric material is molded about the surfaces of said housing within said regions.

19. The battery of claim 14, wherein said housing is a one-piece construction.

20. The battery of claim 14, wherein said dielectric material is in intimate contact with the surfaces of said housing within said regions.

21. A multi-cell battery, comprising:
a housing having one or more partitions dividing said housing into a plurality of regions;
a plurality of electrochemical cells disposed within said regions; and
a dielectric material between said housing and said electrochemical cells, the thermal conductivity of said housing being greater than the thermal conductivity of said dielectric material.

22. The battery of claim 21, wherein said housing consists essentially of a metallic material.

23. The battery of claim 21, wherein said housing consists essentially of aluminum.

24. The battery of claim 21, wherein said dielectric material is a plastic.

25. The battery of claim 21, wherein said battery forms a single pressure vessel for each of the electrochemical cells.

26. The battery of claim 21, wherein said dielectric material comprises a plurality of dielectric inserts, each of said inserts disposed within a corresponding region of said housing.

27. The battery of claim 21, wherein one of said electrochemical cells is disposed in a corresponding region of said housing.

28. The battery of claim 21, wherein said dielectric material is molded about the surfaces of said housing within said regions.

29. The battery of claim 21, wherein said housing is formed as a one-piece construction.

30. The battery of claim 21, wherein said housing is formed by extrusion.

31. The battery of claim 21, wherein said dielectric material is in intimate contact with the surfaces of said housing within said regions.

32. The battery of claim 21, wherein said electrochemical cells are nickel-metal hydride electrochemical cells.

33. The battery of claim 21, wherein said electrochemical cells are coupled in series.
